(19) United States
(12) Patent Application Publication
(10) Pub. No.: US 2015/0093808 A1
(43) Pub. Date: Apr. 2, 2015

(54) ENZYME-ASSISTED EFFLUENT REMEDIATION

(71) Applicant: NOVOZYMES A/S, Bagsvaerd (DK)

(72) Inventors: Gregory DeLozier, Davis, CA (US); John Christiansen, The Woodlands, TX (US)

(21) Appl. No.: 14/563,514

(22) Filed: Dec. 8, 2014

Related U.S. Application Data
(63) Continuation of application No. 13/129,840, filed on Aug. 2, 2011, now abandoned.
(60) Provisional application No. 61/115,594, filed on Nov. 18, 2008.

(51) Int. Cl. C02F 3/34

(52) U.S. Cl. CPC C02F 3/342; C02F 2101/32
USPC 435/281

(57) ABSTRACT

This invention relates to methods to reduce the levels of contaminants in effluent produced in industrial operations, e.g., refinery operations. In particular, the invention relates to method to reduce the level of organic contaminants in industrial effluent wherein said effluent lacks sufficient dissolved oxygen to support enzymatically-catalyzed removal of organic contaminants comprising adding to the effluent one or more enzymes in an amount effective to reduce the level of organic contaminants in said effluent, wherein said enzymes require oxygen for enzymatic activity; and adding an in situ source of dissolved oxygen.

### CROSS-REFERENCE TO RELATED APPLICATIONS

This application is a continuation of U.S. application Ser. No. 13/129,840 filed May 18, 2011, which is a 35 U.S.C. 371 national application of PCT/US2009/64788 filed Nov. 17, 2009, which claims priority or the benefit under 35 U.S.C. 119 of U.S. provisional application No. 61/115,594 filed Nov. 18, 2008, the contents of which are fully incorporated herein by reference.

### BACKGROUND OF THE INVENTION

Petroleum refining generates aqueous effluents containing a variety of phenolic and organic contaminants. Chief among them are emulsified oil globules, polynuclear aromatic hydrocarbons, alkanes, phenolic compounds, organic acids and alcohols. Petroleum effluents may also contain significant levels of ammonia and other amines. More refineries continue to incorporate coking capacity into their operations in order to exploit lower-grade petroleum products. As a consequence, levels of these contaminants have increased to even higher levels. Several operating parameters associated with typical coking processes contribute to increased levels of contaminants, namely the significant quantities of water (necessary to deliver heat (in the form of steam) and to remove residuals such as coke from the coking units); high process temperatures; and the lengthy contact times. To address these problems, the petroleum industry has resorted to use of mechanical and physical separators (e.g. bar screens, API oil water separators, dissolved air/N₂ flotation units, clarifiers, etc.) as well as microorganisms such as nitrifying bacteria, to remove both inorganic and organic contaminants.

### SUMMARY OF THE INVENTION

Applicants' invention provides for effective enzymatic treatment of industrial effluents which have a low oxygen environment, including petroleum industry effluents.

Accordingly, a first aspect of the present invention provides a method to reduce the level of organic contaminants in an industrial effluent wherein said industrial effluent lacks sufficient dissolved oxygen to support enzymatically catalyzed removal of organic contaminants by an enzyme requiring oxygen for enzymatic activity, comprising (a) adding to the effluent one or more enzymes in an amount effective to reduce the level of organic contaminants in said effluent, wherein said enzymes require oxygen for enzymatic activity; and (b) adding an in situ source of dissolved oxygen. In one embodiment, the effluent is a refinery effluent, such as, a petroleum refinery effluent. In another embodiment, the in situ source of dissolved oxygen is one or more peroxide reagents. In another embodiment, the enzyme is an oxidoreductase, such as, laccase or tyrosinase. The enzyme(s) may be used singly or in combination with one or more conventional effluent treatment agents. In various embodiments, the enzyme(s) are added to industrial effluent at points in the waste treatment stream which have low levels of dissolved oxygen and which are not suitable areas for conventional means of aeration. In one embodiment, enzyme is added into petroleum refinery effluent flowing between water treatment units. In particular embodiments, the enzyme may be added between API separators or between a coker unit and coker sump or between coker sump and coker API separator, and/or plant API separator as part of a petroleum refinery water treatment process.

This and other aspects of the present invention will be apparent from the following detailed description of the invention.

### BRIEF DESCRIPTION OF THE DRAWINGS

FIG. 1 is a graph which illustrates the impact of H₂O₂ alone on refinery effluent during 30 minutes of incubation at 50° C., pH 6 as described in Example 1.

FIG. 2 is a graph which illustrates the impact of an embodiment of the present invention, namely H₂O₂ and laccase addition to refinery effluent during 30 minutes of incubation at 50° C., pH 6 as described in Example 1.

FIG. 3 is a graph which illustrates the impact of various doses of laccase, at constant level of H₂O₂, on the total phenolics during 30 minutes of incubation in refinery effluent at pH 6, 50° C.

FIG. 4 is a graph which illustrates the impact of H₂O₂ and laccase addition to effluent from coking operations at a 50,000-barrel per day refinery on nitrification within the biological treatment. The enzyme and peroxide addition commenced with direct injection into the coker sump stream.

FIG. 5 is a graph which illustrates the impact of H₂O₂ and laccase addition to effluent from coking operations at a 50,000-barrel per day refinery on nitrification within the biological treatment.

FIG. 6 is a flow chart which schematically illustrates an example of a water treatment scenario used for a full-scale trial of refinery water treatment with laccase and hydrogen peroxide. EQ=equilibrium tank.

### DETAILED DESCRIPTION

Effluent to be treated according to the methods of the present invention may be referred to herein by various terms, e.g., “waste stream”, “industrial effluent”, and “waste water”. The term “effluent” should also be understood to include “influent”, i.e., water in a water treatment process flowing into one waste water treatment step from a previous step, as well as water flowing between water treatment units. As used herein, these terms all mean effluent produced by industrial operations which contains water (i.e., an aqueous process stream) and organic contaminants, and prior to treatment according to the present invention, have a “low level of dissolved oxygen”, i.e., a concentration of dissolved oxygen insufficient to support enzymatic activity, (e.g., insufficient to catalyze redox reactions) effective to reduce the level of organic contaminants, such as, by at least 5%, more preferably at least 10%, at least 15%, at least 20%, at least 25%, at least 30%, at least 35%, at least 40%, at least 45%, at least 50%, at least 55%, at least 60%, at least 65%, at least 70%, at least 75%, at least 80%, at least 85%, or at least 90%.

Levels of dissolved oxygen in such effluent prior to treatment according to the methods of the present invention may be less than 0.25 ppm, less than 0.24 ppm, less than 0.23 ppm, less than 0.22 ppm, less than 0.21 ppm, less than 0.20 ppm, less than 0.19 ppm, less than 0.18 ppm, less than 0.17 ppm, less than 0.16 ppm, less than 0.15 ppm, less than 0.14 ppm, less than 0.13 ppm, less than 0.12 ppm, less than 0.11 ppm, less than 0.10 ppm, less than 0.9 ppm, less than 0.8 ppm, less than 0.7 ppm, less than 0.6 ppm, less than 0.5 ppm, less than 0.4 ppm, less than 0.3 ppm, less than 0.2 ppm, less than 0.1 ppm, less than 0.09 ppm, less than 0.08 ppm, less than 0.07 ppm, less than 0.06 ppm, less than 0.05 ppm, less than 0.04 ppm, less than 0.03 ppm, less than 0.02 ppm, less than 0.01 ppm, less than 0.009 ppm, less than 0.008 ppm, less than 0.007 ppm, less than 0.006 ppm, less than 0.005 ppm, less than 0.004 ppm, less than 0.003 ppm, less than 0.002 ppm, or even less than 0.001 ppm, or 0 ppm (undetectable dissolved oxygen).

Examples of industrial refinery effluent that may be treated according to the methods of the present invention include petroleum refinery effluent and includes, alone or collectively, desalting waste water, effluent from coking operations, any refinery effluent stream typically referred to as “sour water” (i.e., waters resulting from direct contact with a hydrocarbon stream and which contain sulfides, ammonia, phenols and other organic chemical constituents of crude oil), wash water, scrubber water, and generally any waste streams comprising phenolic compounds. See, e.g., U.S. D.O.E. publication, Water use in Industries of the Future: Petroleum Industry, July 2003, EPA-821-R-04-014, Table 7-4.

Nonlimiting examples of organic contaminants that may be reduced in industrial effluent according to the methods of the present invention include: aromatics, e.g., phenol, benzene, toluene, ethylbenzene, xylene, anthracene and phenanthracene; halogenated hydrocarbons, e.g., trichloroethylene, tetrachloroethylene, perchloroethylene and other chlorinated and brominated hydrocarbons, nitrogen-containing compounds, such as nitrobenzene and cyanide, sulfur-containing compounds, such as mercaptans and aliphatic compounds, like hydrocarbons, alcohols and carboxylic acids. In particular, organic contaminants typically found in petroleum effluent include polynuclear aromatic hydrocarbons, alkanes, phenolic compounds, organic acids and alcohols, sulfides, ammonia, and amines.

As used herein, “remediation” of effluent refers to a reduction in the level of toxic compounds, e.g., organic contaminants in the effluent, by at least 5%, more preferably at least 10%, at least 15%, at least 20%, at least 25%, at least 30%, at least 35%, at least 40%, at least 45%, at least 50%, at least 55%, at least 60% at least 65%, at least 70%, at least 75%, at least 80%, at least 85%,or at least 90%. The reduction may reach levels such that the effluent may be clean enough by prevailing industry and/or governmental standards to permit discharge or reuse of the effluent. Standard methods for measuring the level of toxic compounds present in effluent, as well as discharge limits and related industry standards, are familiar to one of skill in the art.

Enzymes for use in the methods of the present invention require oxygen to reduce the amount of organic contaminants in the effluent. These enzymes most typically include oxidoreductases. “Oxidoreductase enzymes” or “oxidoreductases” refer to enzymes which catalyze oxidoreduction (redox) reactions, i.e., the transfer of hydrogen (H) and oxygen (O) atoms or electrons from one substance to another. Enzymes for use in the methods of the present invention include enzymes classified as EC 1 in the EC number classification system of enzymes, for example, enzymes belonging to subclasses 1-21 and 97, particularly enzymes belonging to subclasses 1, 3, 4, 7, 8, 10, and 14 and where oxygen is the “acceptor” (sub-subclass 3). Examples include enzymes from EC 1.1.3 (e.g., glucose oxidase, alcohol oxidase); EC 1.3.3.5 (e.g., bilirubin oxidase); EC 1.4.3.6 (e.g., copper amine oxidase); EC 1.10.3 (e.g., catechol oxidase, tyrosinase, laccase); EC 1.13.11 (e.g., catechol dioxygenase, lipoxygenase); and EC 1.14.18.1 (e.g., monophenol monooxygenase).

Enzymes for use according to the methods of the present invention are familiar to one of skill in the art, and may be obtained from various commercial sources of industrial enzymes, e.g., Novozymes NS. In one particular embodiment, the enzyme is laccase (EC 1.10.3.2). Laccases catalyze the oxidation of a variety of phenolic compounds. Suitable laccase enzymes may be derived or obtained from any suitable origin, including, bacterial, fungal, yeast or mammalian origin. Fungal sources of laccase include, e.g., wild type and functional mutants of laccase obtained from Aspergillus, Neurospora, e.g., N. crassa, Podospora, Botrytis, Collybia, Fomes, Lentinus, Pleurotus, Trametes, e.g., T. villosa and T. versicolor, Rhizooctonia, e.g., R. solani, Coprinus, e.g., C. cinereus, C. comatus, C. friesii, and C. plicatilis, Psathyrella, e.g., P. condelleana, Panaeolus, e.g., P. papilionaceus, Myceliophthora, e.g., M. thermophila, Scytalidium, e.g., S. thermophilum, Polyporus, e.g., P. pinsitus, Pycnoporus, e.g., P. cinnabarinus, Phlebia, e.g., P. radita (WO 92/01046), or Coriolus, e.g., C. hirsutus (JP 2-238885). See, e.g., U.S. Pat. Nos. 5,480,801; 5,795,760; 5,770,419; 5,770,418; 5,843,745; 6,008,029; 5,998,353; 5,925,554; 5,985,818; 6,060,442.

Suitable laccase enzymes may also be obtained from bacteria, e.g., from a strain of Bacillus.

As used herein, the term “obtained” means that the enzyme may have been isolated from an organism which naturally produces the enzyme as a native enzyme. The term “obtained” also means herein that the enzyme may have been produced recombinantly in a host organism.

Enzymes suitable for use in the present invention may also be obtained via recombinant techniques. Since most organisms that produce enzymes do so at levels that are far too low to be an economical source, genes for enzymes having industrial applications have been cloned and expressed in suitable organisms to permit the generation of large quantities. Use of such organisms to produce enzymes for use in the methods of the present invention is contemplated herein. The recombinantly produced enzyme may be either native or foreign to the host organism and may have a modified amino acid sequence, e.g., having one or more amino acids which are deleted, inserted and/or substituted, i.e., a recombinantly produced enzyme which is a mutant and/or a fragment of a native amino acid sequence or an enzyme produced by nucleic acid shuffling processes known in the art. Encompassed within the meaning of a native enzyme are natural variants and within the meaning of a foreign enzyme are variants obtained recombinantly, such as by site-directed mutagenesis or shuffling. In one example, laccase for use in the methods of the present invention may be derived from Myceliophthora thermophila and may be produced recombinantly in a fungal host such as Aspergillus. See, e.g., U.S. Pat. No. 5,925,554; U.S. Pat. No. 6,242,232; U.S. Pat. No. 5,795,760; U.S. Pat. No. 5,770,419; U.S. Pat. No. 5,770,418; U.S. Pat. No. 5,985,818; U.S. Pat. No. 5,998,353; and U.S. Pat. No. 6,207,430.

Enzymes for use in the methods of the present invention are commercially available in a variety of convenient forms and may be formulated for introduction directly into the effluent according to any means which preserves the functional integrity of the enzymes. In various embodiments this may include, e.g., direct injection of enzyme into effluent in liquid, e.g., aqueous form, use as granulates, non-dusting granulates, or as a dry powder or as a protected enzymes. Granulates may be produced, e.g., as disclosed in U.S. Pat. Nos. 4,106,991 and 4,661,452, and may optionally be coated by processes known in the art. Protected enzymes may be prepared according to the process disclosed in EP 238,216. In other embodiments, the enzymes may be used with synthetic and/or natural, organic and/or inorganic supports, e.g., on beads, or may be placed in a permeable container or supported on a membrane or other means of support and placed in the effluent according to conventional methods.

Enzymes used in the methods of the present invention may be used in combination with agents which may minimize the inactivation of the enzyme and/or increase their efficiency in the effluent. Such agents are known in the art and include stabilizers such as a sugar, a sugar alcohol or other polyol, lactic acid or other organic acid. An aqueous formulation of laccase suitable for use according to the methods of the present invention may contain, for example, 3% laccase, 66% water, and 2% glycine, 25% propylene glycol, and 4% sucrose/glucose as stabilizers. Enzymes may also be used in combination with agents that may prevent enzyme from adhering to and precipitating with the polymers produced by the oxidation of organic contaminants in the effluent. Agents suitable for such uses may be discerned by one of skill in the art.

Generally, enzyme addition to effluent should be at a point in the effluent treatment process that allows for sufficient mixing of enzyme into the effluent in order to permit effective contact between enzyme and substrate. Addition point(s) may also be at points in the effluent which have low levels of dissolved oxygen and which are not suitable areas for conventional means of aeration, such as forced aeration or cascading. For example, in an industrial effluent treatment process, enzyme may be added into water flowing between water treatment units, e.g., in a petroleum refinery treatment process, the enzyme may be added between API separators or between a coker unit and coker sump or between coker sump and coker API separator, and/or plant API separator as part of a petroleum refinery water treatment process. See, e.g., U.S. D.O.E. publication, Water use in Industries of the Future: Petroleum Industry, July 2003, EPA-821-R-04-014, Table 7-8.

While the methods of the present invention may employ purified or semi-purified forms of enzymes, the methods may also include the use of non-purified forms. In addition, the methods can employ enzyme-producing microorganisms directly or indirectly in the effluent treatment process. Organisms for use in this matter would be capable of existing in effluent treatment conditions, e.g., conditions characterized by minimal light and air/liquid interactions, high levels of inorganic and organic contaminants, and a low oxygen environment, as described herein. Organisms suitable for use in this manner may be discerned by one of skill in the art according to conventional methods.

The term “purified” as used herein covers enzymes free from (including, substantially free, e.g., at least 75% (w/w) pure) other components from the organism from which it is derived. The term “purified” also covers enzymes free from components from the native organism from which it is obtained. The enzymes may be purified, with only minor amounts of other proteins being present. The expression “other proteins” relate in particular to other enzymes. The term “purified” as used herein also refers to removal of other components, particularly other proteins and other enzymes present in the cell of origin of the enzyme of the invention. The enzyme may be “substantially pure,” that is, free from other components from the organism in which it is produced, that is, for example, a host organism for recombinantly produced enzymes.

The enzymes for use in the present invention are used “in an amount effective to reduce the level of organic contaminants” in an effluent. The actual amount of an enzyme (alone or in combination with other agents) added to the effluent necessary to achieve a desired reduction in organic contaminants may vary based on a variety of factors, e.g., type of effluent, including type of organic contaminants contained therein, activity level of a particular enzyme variant or batch or enzyme, effluent temperature and pH, to name a few variables. Such amounts may be determined by one of skill in the art. In some embodiments, the enzyme is dosed in an amount of about 0.1 to about 100 mg enzyme protein/L effluent. In other embodiments, the enzyme dose is about 1 to about 10 mg/L effluent.

Effective enzymatic reduction of organic contaminants in effluent is related to various factors, e.g., the activity of enzyme employed in effluent treatment operations. Thus, the ability of the enzyme to reduce the level of organic contaminants from effluent may be optimized by manipulating the treatment conditions to optimize catalytic activity. The conditions selected for optimization, as well as the range of each condition, will vary depending on the qualities of the effluent to be treated and may be discerned by one of skill in the art.

Similarly, one may modify effluent conditions to optimize pH, flow rate and/or temperature to facilitate reactions catalyzed by a particular enzyme(s) or microorganisms employed in the effluent treatment process. For example, regarding select enzymes, temperature optima are generally a function of pH and vice versa. In turn, these optima are a function of the substrate. All conditions of pH, temperature and substrate (chemical structure, molecular weight, concentration, charge, etc.) may vary between specific refinery streams and at various points along the water treatment system. In addition, the pH and temperature optima of enzymes can vary, e.g., pH and temperature optima of a wild-type protein may be different than a variant form of the protein.

Effluent to be treated according to methods of the present invention may have a pH ranging from acidic to basic, e.g., in one nonlimiting example, the pH of the effluent may be between about pH 4 and about pH 9. Enzymes genetically engineered to be catalytically active at various pH values are commercially available (Novozymes NS), thus, one of skill in the art can purchase an enzyme suitable to treat an effluent having activity at a particular pH value or pH range. In addition, in one embodiment, the pH of the effluent may also be adjusted to optimize organic contaminant removal by a particular enzyme according to the methods of the present invention. Methods for adjusting the pH of a waste stream are well-known to those of skill in the art. Nonlimiting examples of such adjustment methods include addition of base to increase pH or addition of acid to lower pH, as well as buffer systems. Acids and bases that can be used to adjust effluent pH are familiar to one of skill in the art and include, e.g., HCl, acetic acid, NaOH, Ba₂OH, and KOH.

Industrial effluent of different temperature may also be treated according to the methods disclosed herein. In one nonlimiting example, the temperature of the effluent to be treated may be between about 20° C. and about 100° C. Enzymes genetically engineered for optimal activity at various temperatures may be purchased from suppliers of industrial enzymes (Novozymes NS) for use in the methods of the present invention. In another embodiment, the temperature of the effluent may be adjusted to optimize enzymatic-assisted remediation of industrial effluent according to conventional methods. Determination of optimum temperature for remediation of effluent by a particular enzyme or combination of enzymes is possible by one of skill in the art.

As used herein, an “in situ source of dissolved oxygen suitable to support enzymatic activity” refers to any and all means by which oxygen molecules may be generated in industrial effluent in sufficient quantities to allow enzymatically-mediated reduction of organic contaminants in the effluent. In one particular embodiment, the methods of the present invention comprise the addition of peroxides.

Peroxides suitable for use in the methods of the present invention include hydrogen peroxide and any other peroxide or peroxide generating source which produces molecular oxygen upon decomposition. Peroxides may be added to the effluent before, after, or in conjunction with enzyme addition. For example, peroxides may be added to a waste stream a certain distance before or after the point in the stream at which enzyme is added. The dissociation of the peroxide to produce molecular oxygen may be catalyzed by transition metals present in the effluent. The peroxide may also undergo decomposition in the effluent due to enzymatic activity. Thus, it is understood herein that the methods of the present invention embrace not only the addition of peroxides to the effluent but also the addition of catalase, peroxidase or other suitable enzyme as needed to accelerate or enhance peroxide decomposition. In some conditions, laccase from Myceliopthera can exhibit catalase-like behavior and can promote peroxide decomposition.

The amount of peroxide added to the effluent is sufficient to produce levels of dissolved oxygen which support enzymatic remediation of organic contaminants in the effluent, as described herein. Such amounts may be determined by one of skill in the art. They may vary depending on numerous factors, such as the activity level and amount of enzyme added to the effluent, as well as the molar concentration and chemical composition of oxidizable species per unit volume of effluent to be treated. These factors may also vary according to effluent treatment design and operation. It is understood that, as discussed above, effluent conditions may be optimized in order to support peroxide decomposition and the generation of the maximum amount of oxygen in situ.

Ideally, enzyme is added to the effluent at a point where suitable pH and temperature conditions exist for enzyme activity but levels of dissolved oxygen in the effluent are such that the enzyme will not have sufficient electron acceptors to drive redox reactions ab initio. Enzyme application under such oxygen limiting conditions may exhaust available dissolved oxygen without significant reduction in organic contaminants in the effluent, i.e., a reduction in organic contaminants of at least 5% to 90%.

Enzymes for use in the present invention may be used alone or in conjunction with other effluent treatment agents. As used herein, “other effluent treatment agent” may include reagents or other substances used in conventional effluent treatment methods. For example, in certain embodiments, laccase may be used in combination with other enzymes capable of degrading organic compounds but which do not require molecular oxygen for catalytic activity. Examples include peroxidases, hydroxylases, oxygenases and reductases. These enzymes may be obtained from commercial sources familiar to one of skill in the art or produced recombinantly according to conventional methods as described above. Suitable amounts for use may vary depending on effluent conditions and may be discerned by one of skill in the art.

Other treatment methods to treat petroleum refinery effluent include physical means (e.g., screening and filtering), chemical means (e.g., induced/dissolved gas/air/nitrogen flotation), and biological means (e.g., nutrient removal using activated sludge units, rotating biological contactors, or aerated lagoons).

The methods of the present invention may be used at any point in an effluent treatment process, and may be employed more than once. In particular, water treatment steps may include separation, flotation, partition, precipitation or sedimentation of contaminating substances and the efficacy of such processes may be enhanced by enzymatic pre-treatment of the effluent prior to and within these treatment units. In addition, as described in the examples below, enzymatic treatment of effluent before (or “upstream to”) treatment with microorganisms may be particularly beneficial as such enzymatic treatment can decrease the level and/or the toxicity of toxic compounds to which these microorganisms are exposed and can thus enhance their efficiency in such water and residuals treatment processes as, e.g., nitrification, denitrification, biological oxygen demand/chemical oxygen demand (BOD/COD) removal, aerobic/anerobic digestion, and methanogenesis.

Levels of organic contaminants reduced from industrial effluent according to the methods of the present invention may be measured as a reduction in total phenolic compounds in the effluent using conventional methods. Effective reduction by at least 5%, more preferably at least 10%, at least 15%, at least 20%, at least 25%, at least 30%, at least 35%, at least 40%, at least 45%, at least 50%, at least 55%, at least 60% at least 65%, at least 70%, at least 75%, at least 80%, at least 85%, or at least 90% is contemplated.

In order to fully illustrate the present invention and advantages thereof, the following specific examples are given, it being understood that they are intended only as illustrative and in no way limitative.

### EXAMPLES

### Example I

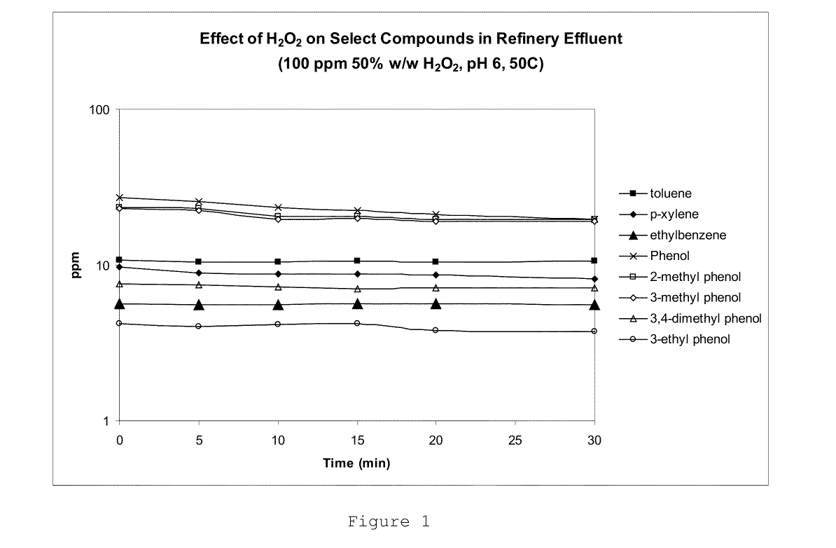

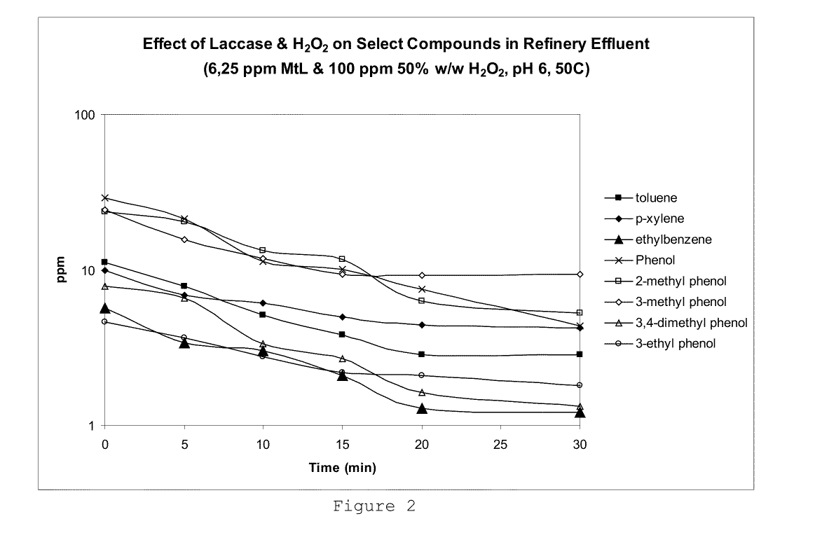

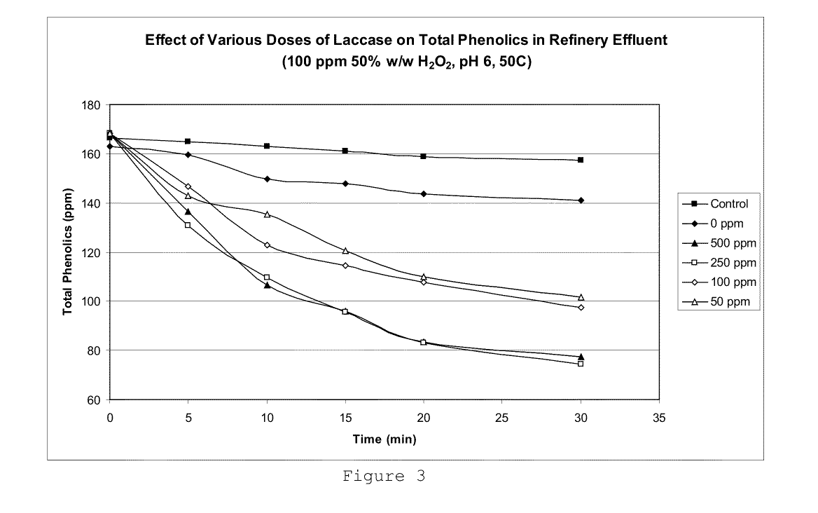

Laboratory trials were conducted at Auburn University (Auburn, Ala., USA) to explore the application of Myceliophthora thermophila laccase (MtL), and hydrogen peroxide into refinery effluent. Except for the control, 50% w/w hydrogen peroxide was added to each sample of refinery effluent at a dose of 100 ppm. MtL was added at doses of 0, 0.625, 1.25, 3.125 and 6.25 mg of enzyme protein per liter of refinery effluent. The samples were incubated at 50° C. for 30 minutes. At time 0, 5, 10, 15, 20, 25 and 30 minutes, aliquots were taken from each sample and various phenolic and aromatic species were quantified by gas chromatography and mass spectrophotometry (GCMS). In addition, residual hydrogen peroxide levels as a function of time were monitored during the trial. The results, presented graphically herein as FIGS. 1 and 2, demonstrate that although hydrogen peroxide has limited effect on select organics in the refinery effluent, the laccase and peroxide treatment can significantly reduce the concentration of multiple organics within the effluent over the 30 minute trial period. FIG. 3 presents the ability of the laccase/peroxide system to reduce the total phenolics in the refinery effluent as a function of time. While peroxide addition alone can remove ˜10% of the total phenolics, peroxide in the presence of 6.25 ppm laccase can remove over 50% of the total phenolics.

### Example II

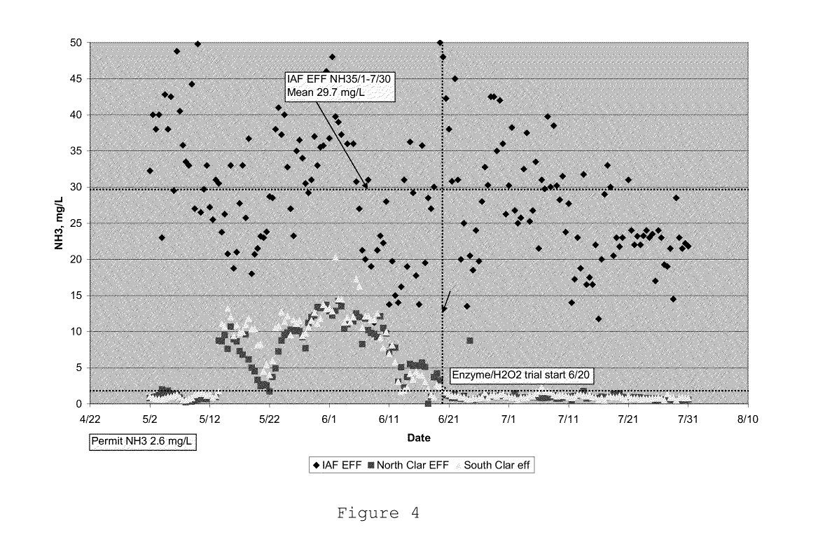

The laboratory experiments described in Example I were followed by a full-scale trial within the effluent management operations of a 50,000-barrel per day refinery with coking capacity. Peroxide and MtL were dosed into effluent prior to the coker transfer sump. During the trial, chemical oxygen demand (COD), NH₃, NO₂, and total phenolics in various streams were constantly quantified for comparison to historical baseline data. FIG. 4 presents the impact of the laccase and peroxide treatment on NH₃ removal. As illustrated, during the trial, NH₃ levels in the feed to the biological treatment system (IAF EFF) remained similar to pre-trial levels (˜29.7 mg/L). However, NH₃ levels in the effluent from the biological treatment (“North & South Clarifier effluent”) are maintained below the permitted 2.6 mg/L for the duration of the trial.

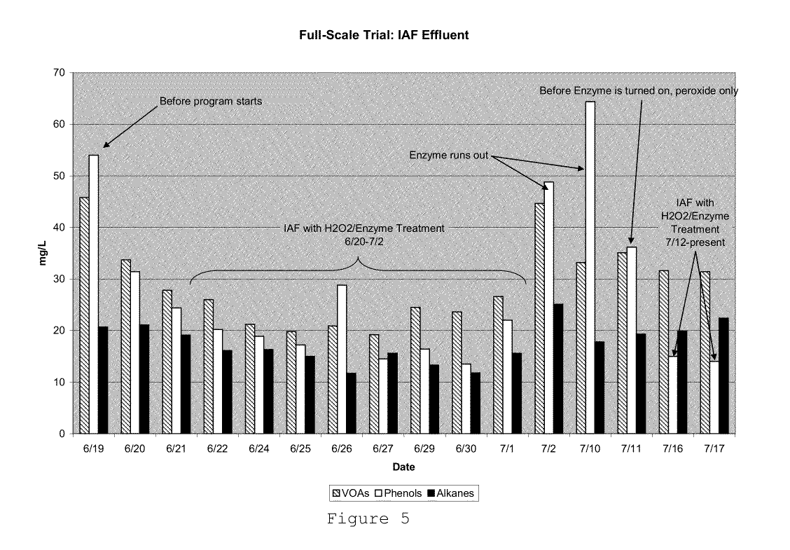

The nitrifiers within the biological treatment system were extremely sensitive to toxic compounds (e.g. substituted phenolics) and the results indicate that the combination of laccase and peroxide facilitate removal/detoxification of such compounds and measurably improve the health and therefore the nitrifying performance of these microorganisms. FIG. 5 presents data corresponding to the levels of volatile organic acids (VOA), total phenolics and alkanes detected in the effluent leaving the dissolved air flotation unit before, during and after the trial. The enzyme and peroxide addition commenced with direct injection into the coker sump stream. Before, during and after the trial, volatile organic acids (VOA), total phenols and alkanes within the dissolved air flotation (“IAF”) effluent (i.e., the influent to the biological treatment stage) were quantified.

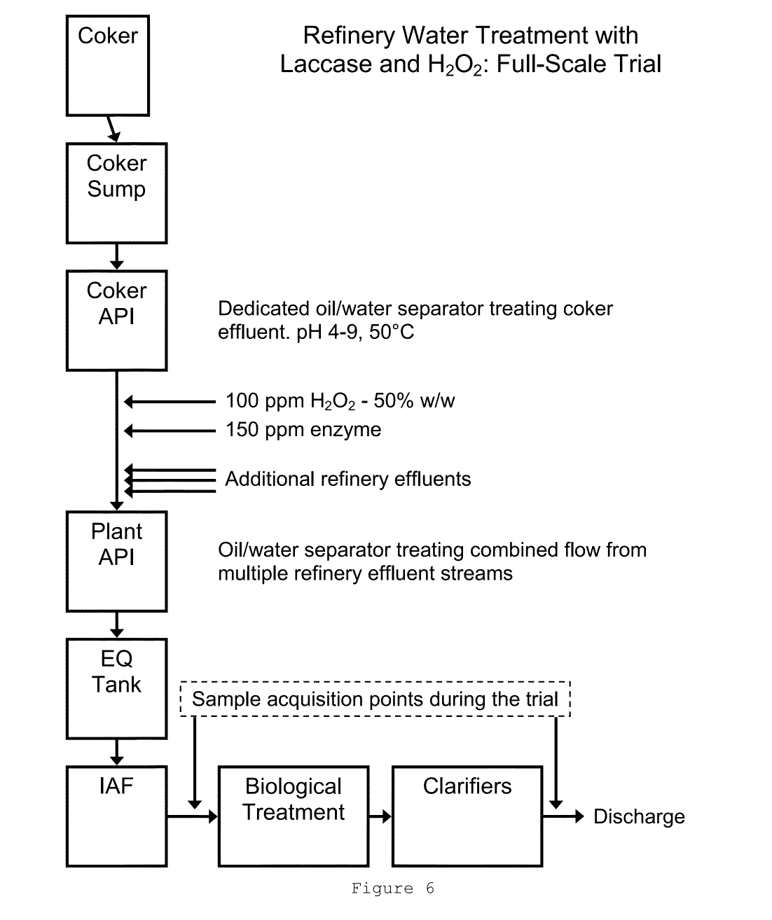

It is clear that the addition of H₂O₂ and laccase significantly reduced the amount of phenolics and VOAs within this stream. This was underscored by the sudden spike in these compounds when laccase was removed from the system and the recovery when enzyme was returned to the system. Such results indicate that the enzymatic treatment enhanced the performance of one or more of the treatment units (i.e., an API oil water separator and a dissolved air flotation stage), thereby reducing the amount of toxic compounds that are sent to the biological treatment stage. This readily explains the improved nitrification during the laccase and peroxide addition observed in FIG. 4. A schematic of this trial is provided herein as FIG. 6.

All publications cited in the specification are indicative of the level of skill of those skilled in the art to which this invention pertains. All these publications are herein incorporated by reference in their entirety to the same extent as if each individual publication were specifically and individually indicated to be incorporated by reference.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A method to reduce the level of organic contaminants in a petroleum refinery effluent wherein said petroleum refinery effluent lacks sufficient dissolved oxygen to support enzymatically catalyzed removal of organic contaminants by an oxidoreductase enzyme requiring oxygen for enzymatic activity, comprising
(a) adding to the petroleum refinery effluent one or more oxidoreductase enzymes in an amount effective to reduce the level of organic contaminants in said effluent, wherein said enzymes require oxygen for enzymatic activity; and
(b) adding an in situ source of dissolved oxygen.

2. The method of claim 1 wherein said oxidoreductase is laccase, tyrosinase, or other oxidoreductase enzyme which requires oxygen for enzymatic activity.

3. The method of claim 1 wherein one or more peroxide reagents is added as the in situ source of dissolved oxygen.

4. The method of claim 1 wherein said enzymes are used in combination with one or more other effluent treatment agents.

5. The method of claim 1, wherein prior to said step b), the effluent has a concentration of dissolved oxygen insufficient to support enzymatic redox reactions effective to reduce the level of organic contaminants by at least 5%, at least 10%, at least 15%, at least 20%, at least 25%, at least 30%, at least 35%, at least 40%, at least 45%, at least 50%, at least 55%, at least 60%, at least 65%, at least 70%, at least 75%, at least 80%, at least 85%, or at least 90%.

6. The method of claim 1, wherein prior to said step b), the effluent has an amount of dissolved oxygen of less than 0.25 ppm, less than 0.24 ppm, less than 0.23 ppm, less than 0.22 ppm, less than 0.21 ppm, less than 0.20 ppm, less than 0.19 ppm, less than 0.18 ppm, less than 0.17 ppm, less than 0.16 ppm, less than 0.15 ppm, less than 0.14 ppm, less than 0.13 ppm, less than 0.12 ppm, less than 0.11 ppm, less than 0.10 ppm, less than 0.9 ppm, less than 0.8 ppm, less than 0.7 ppm, less than 0.6 ppm, less than 0.5 ppm, less than 0.4 ppm, less than 0.3 ppm, less than 0.2 ppm, less than 0.1 ppm, less than 0.09 ppm, less than 0.08 ppm, less than 0.07 ppm, less than 0.06 ppm, less than 0.05 ppm, less than 0.04 ppm, less than 0.03 ppm, less than 0.02 ppm, less than 0.01 ppm, less than 0.009 ppm, less than 0.008 ppm, less than 0.007 ppm, less than 0.006 ppm, less than 0.005 ppm, less than 0.004 ppm, less than 0.003 ppm, less than 0.002 ppm, less than 0.001 ppm, or 0 ppm.

7. The method of claim 1, wherein the effluent is selected from the group consisting of desalting waste water, effluent from coking operations, waters resulting from direct contact with a hydrocarbon stream and which contain sulfides, ammonia, phenols and other organic chemical constituents of crude oil, wash water, scrubber water.

8. The method of claim 1, wherein the enzyme is added into said petroleum refinery effluent flowing between effluent treatment units.

9. The method of claim 8 wherein the enzyme is added between one or more API separators, between a coker unit and a coker sump, between a coker sump and a coker API separator, or between a coker sump and a plant API separator.

10. A method to reduce the level of organic contaminants in a petroleum refinery effluent wherein said effluent lacks sufficient levels of dissolved oxygen to support enzymatically catalyzed removal of organic contaminants by an enzyme requiring oxygen for enzymatic activity, comprising adding to the effluent
(a) a laccase in an amount effective to reduce the level of organic contaminants in said effluent; and
(b) peroxide or a peroxide generating source.

11. The method of claim 10 wherein said laccase is used in combination with one or more other effluent treatment agents.

12. The method of claim 10, wherein prior to said peroxide addition, the effluent has a concentration of dissolved oxygen insufficient to support laccase treatment effective to reduce the level of organic contaminants by at least 5%, at least 10%, at least 15%, at least 20%, at least 25%, at least 30%, at least 35%, at least 40%, at least 45%, at least 50%, at least 55%, at least 60% at least 65%, at least 70%, at least 75%, at least 80%, at least 85%,or at least 90%.

13. The method of claim 10, wherein the laccase is added to said effluent flowing between effluent treatment units.

14. The method of claim 13 wherein the laccase is added between API separators, between a coker unit and coker sump, between coker sump and coker API separator, or between coker sump and plant API separator as part of a petroleum refinery water treatment process.

15. The method of claim 10, wherein prior to said peroxide addition, the effluent has an amount of dissolved oxygen of less than 0.25 ppm, less than 0.24 ppm, less than 0.23 ppm, less than 0.22 ppm, less than 0.21 ppm, less than 0.20 ppm, less than 0.19 ppm, less than 0.18 ppm, less than 0.17 ppm, less than 0.16 ppm, less than 0.15 ppm, less than 0.14 ppm, less than 0.13 ppm, less than 0.12 ppm, less than 0.11 ppm, less than 0.10 ppm, less than 0.9 ppm, less than 0.8 ppm, less than 0.7 ppm, less than 0.6 ppm, less than 0.5 ppm, less than 0.4 ppm, less than 0.3 ppm, less than 0.2 ppm, less than 0.1 ppm, less than 0.09 ppm, less than 0.08 ppm, less than 0.07 ppm, less than 0.06 ppm, less than 0.05 ppm, less than 0.04 ppm, less than 0.03 ppm, less than 0.02 ppm, less than 0.01 ppm, less than 0.009 ppm, less than 0.008 ppm, less than 0.007 ppm, less than 0.006 ppm, less than 0.005 ppm, less than 0.004 ppm, less than 0.003 ppm, less than 0.002 ppm, less than 0.001 ppm, or 0 ppm.

16. The method of claim 10, wherein the effluent is selected from the group consisting of desalting waste water, effluent from coking operations, waters resulting from direct contact with a hydrocarbon stream and which contain sulfides, ammonia, phenols and other organic chemical constituents of crude oil, wash water, scrubber water.
